(19) United States
(12) Patent Application Publication
(10) Pub. No.: US 2025/0092917 A1
(43) Pub. Date: Mar. 20, 2025

(54) PASSIVE MAGNETIC BEARING USING DIAMAGNETIC LEVITATION

(71) Applicant: International Business Machines Corporation, Armonk, NY (US)

(72) Inventors: Oki Gunawan, Westwood, NJ (US); Josephine Monica, Ithaca, NY (US)

(21) Appl. No.: 18/466,860

(22) Filed: Sep. 14, 2023

(51) Int. Cl. F16C 39/06; H01F 7/02

(52) U.S. Cl. CPC F16C 39/063; H01F 7/0236

(57) ABSTRACT

A passive magnetic bearing using diamagnetic levitation including a first dipole magnet and a second dipole magnet disposed substantially in parallel. A levitating diamagnet is at least partially disposed in between the first dipole magnet and the second dipole magnet. A load is at least partially disposed on the levitating diamagnet.

### BACKGROUND

Exemplary embodiments of the present invention relate to a passive magnetic bearing, and more particularly, to a passive magnetic bearing using diamagnetic levitation.

A magnetic bearing is a contact-free bearing that supports loads through magnetic levitation. Due to its contact-free operation, the magnetic bearing has several advantages over standard bearings, which include lower friction and heat energy dissipation, lower mechanical wear, lower noise, lower vibration, longer life cycle, and lower required maintenance. In addition, a magnetic bearing can support high-speed rotation and has many industrial applications, including generators, pumps, turbines, compressors, and flywheels in energy storage systems. Current magnetic bearing technology can generally be classified into passive and active magnetic bearings.

Passive magnetic bearings use permanent magnets for levitation; hence they do not require power input. However, levitation using only permanent magnets cannot achieve stable equilibrium, as prescribed by Earnshaw's theorem. Thus, the axial direction is unstable for radial bearing configuration, whereas the radial direction is unstable for axial bearing configuration. Consequently, stabilization requires other mechanisms, such as servo-controlled system or contact bearing. Many works focus on solving this instability issue. Bassani et al. explores techniques to achieve dynamic stability of a permanent magnet bearing and explores techniques and designs to achieve bearings with low instability. However, their potential stiffness often varies with displacement, making them hard to control. Bjork et al. proposes a nested conical passive magnetic bearing design and optimizes the tilt angle to achieve an almost constant stiffness property, allowing an easier control scheme. However, this constant stiffness configuration also results in the lowest lifting capability.

The instability of passive magnetic bearings limits their designs and technical uses. Additionally, passive magnetic bearings still require an additional active/conventional bearing to control and stabilize them. Thus, current magnetic bearing technologies mostly use active magnetic bearings. Active magnetic bearings use electromagnet and active feedback control systems to stabilize the system. Different controller techniques typically used in active magnetic bearings include PID controllers, LQG/LTR H∞ and adaptive controllers.

However, all these techniques require expensive and complicated position/gap sensor installation and feedback mechanisms. Additionally, position sensors are typically noisy, which may cause undesirable effects such as vibrations and imbalances. To address this problem, Schuhmann et al. implements an extended Kalman filter and optimal state feedback regulator to get a more accurate estimate of the rotor position and achieve better system dynamics. Finally, active magnetic bearings require a large power input to support a load. Thus, some works also propose a hybrid design utilizing permanent magnets to offset the load and active bearings to control and stabilize the load.

### SUMMARY

According to an embodiment of the present invention, a passive magnetic bearing using diamagnetic levitation is provided including a first dipole magnet and a second dipole magnet disposed substantially in parallel. The first dipole magnet and the second dipole magnet are substantially linear. A levitating diamagnet is at least partially disposed on the first dipole magnet and the second dipole magnet. The levitating diamagnet is substantially linear. A load is at least partially disposed on the levitating diamagnet.

According to an embodiment of the present invention, a passive magnetic bearing using diamagnetic levitation is provided including at least one dipole magnet pair. The at least one dipole magnet pair includes a first dipole magnet and a second dipole magnet disposed substantially in parallel. The first dipole magnet and the second dipole magnet are a substantially round shape in a top-view. At least one levitating diamagnet is at least partially disposed on the first dipole magnet and the second dipole magnet. The at least one levitating diamagnet is substantially circular in a top-view. A load is at least partially disposed on the at least one levitating diamagnet.

According to an embodiment of the present invention, a passive magnetic bearing using diamagnetic levitation is provided including a plurality of dipole magnet pairs. Each of the plurality of dipole magnet pairs include a first dipole magnet and a second dipole magnet disposed substantially in parallel to one another. The first dipole magnet and the second dipole magnet are a substantially circular shape in a top-view. A levitating diamagnet is at least partially disposed on the first dipole magnet and the second dipole magnet of each of the plurality of dipole magnet pairs. The levitating diamagnet is a substantially circular shape in a top-view. A load is at least partially disposed between the plurality of dipole magnet pairs. A shaft is connected to the load.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIGS. 1A, 1B, 1C and 1D each illustrate a different cross-sectional shape of a passive magnetic bearing using diamagnetic levitation 100, in accordance with exemplary embodiments of the present invention.

FIG. 2 illustrates a graph of load-bearing capacity (LBC) versus radius (R) for the passive magnetic bearing using diamagnetic levitation 100 depicted in FIG. 1A.

FIGS. 3A and 3B illustrate perspective views of the passive magnetic bearing using diamagnetic levitation 100 as included in a linear and a circular track, respectively, in accordance with exemplary embodiments of the present invention.

FIG. 4 illustrates a passive magnetic bearing using diamagnetic levitation 200 capable of rotating a load, in accordance with an exemplary embodiment of the present invention.

FIG. 5 illustrates a passive magnetic bearing using diamagnetic levitation 300 capable of rotating a shaft, in accordance with an exemplary embodiment of the present invention.

It is to be understood that the included drawings are not necessarily drawn to scale/proportion. The included drawings are merely schematic examples to assist in understanding of the present invention and are not intended to portray fixed parameters. In the drawings, like numbering may represent like elements.

### DETAILED DESCRIPTION

Exemplary embodiments of the present invention are disclosed hereafter. However, it shall be understood that the scope of the present invention is dictated by the claims. The disclosed exemplary embodiments are merely illustrative of the claimed passive magnetic bearing using diamagnetic levitation. The present invention may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment,” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present invention, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present invention according to various exemplary embodiments.

The present invention relates to a passive magnetic bearing system based on diamagnetic levitation suspension using multiple dipole magnets (e.g., dipole-line magnets) or diametric magnets and a diamagnetic object. The diamagnetic levitation suspension offers an advantage of passive bearing suspension that eliminates the power input requirement and complexity of active magnetic bearing reliant mechanisms. The present invention can serve as linear and/or a rotational bearing depending on the shape of a magnetic dipole-line track. The present invention will also be very attractive for very-high LBC magnetic bearing applications using room temperature superconductors once this technology becomes available soon.

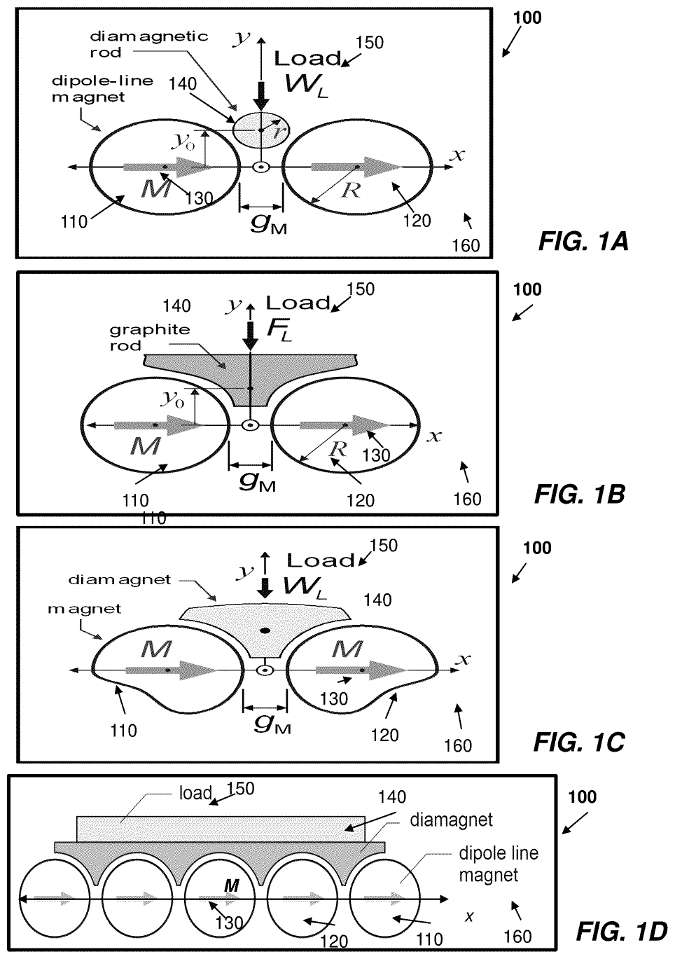

FIGS. 1A, 1B, 1C and 1D each illustrate a different cross-sectional shape of a passive magnetic bearing using diamagnetic levitation 100, in accordance with exemplary embodiments of the present invention.

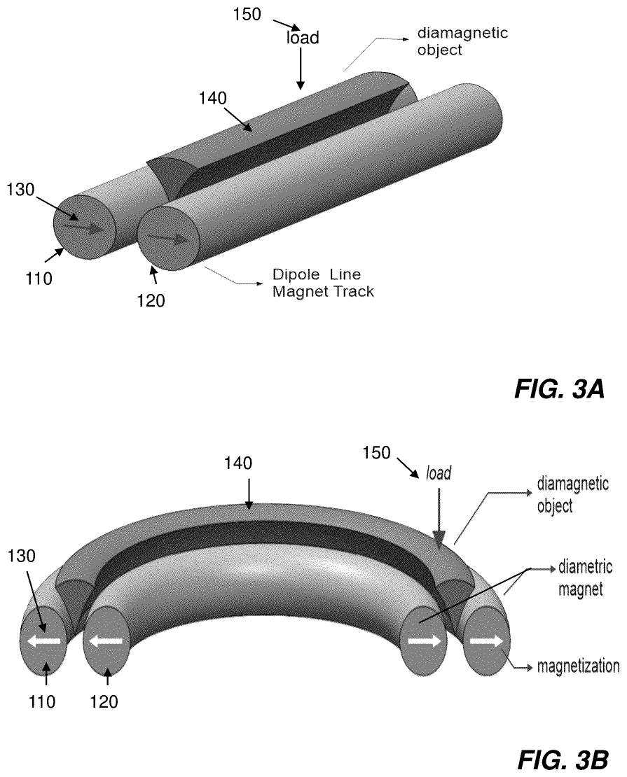

The passive magnetic bearing using diamagnetic levitation 100 can include a plurality of dipole magnets (e.g., dipole-line magnets) disposed in parallel. The plurality of dipole magnets can include a first dipole-line magnet 110 and a second dipole-line magnet 120. The first dipole-line magnet 110 and the second dipole-line magnet 120 can represent a pair. The plurality of dipole-line magnets can have a magnetic field 130 (e.g., permanent, transient, inducible, etc.), such as a diamagnetic field. Dipole-line magnets 110/120 can include a radius R and magnetization M. At least some of the magnetic fields 130 can have a substantially same x direction (e.g., a lateral direction) of magnetization M. The plurality of dipole-line magnets 110/120 can have various cross-section shapes which can extend in a substantially lengthwise direction (e.g., as a linear track as depicted in FIG. 3A). For example, the plurality of dipole-line magnets 110/120 can have a substantially round (e.g., oval, ellipse, irregular circle, etc.) cross-section shape, as illustrated in FIGS. 1A-1D.

A levitating diamagnet 140 (e.g., a graphite object/rod, bismuth object/rod, etc.) can be at least partially disposed on surfaces of the plurality of dipole-line magnets 110/120 (e.g., the dipole-line magnet pairs/linear track). The levitating diamagnet 140 can also have various cross-section shapes, such as a circle (illustrated in FIG. 1A) or a shape with a lower surface that corresponds to the shape of the upper and/or inner surfaces of the dipole-line magnet pair on which it is disposed (illustrated in FIGS. 1B-1D). The levitating diamagnet 140 can extend in a substantially lengthwise direction (e.g., along the linear track as depicted in FIG. 3A). The levitating diamagnet 140 can be suspended in a substantially perpendicular direction relative to the direction of the magnetic field(s) 130. A load 150 can be disposed on the levitating diamagnet 140. A levitating diamagnet (also referred to herein as a diamagnetic rod, a diamagnetic object, or a diamagnet) 140 of cylindrical shape has a mass density p and magnetic susceptibility χ and radius r.

Load bearing capacity (LBC) is defined as the maximum amount of load mass per unit length (excluding the diamagnet) in which the system can still sustain levitation. The system can also be optimized to include a predetermined cross-section shape for at least one of the dipole-line magnets 110/120 and the levitating diamagnet 140 to maximize the LBC further and/or to reduce material cost.

According to an exemplary embodiment, as depicted in FIG. 1D, the quantity of dipole-line magnets 110/120 (e.g., pairs) can be increased in proportion to a desired LBC and/or load 150 size and the corresponding levitating diamagnets 140 can be connected accordingly (e.g., integrated in a cross-sectional view). The damping of the system including the passive magnetic bearing using electromagnetic levitation 100 can also be controlled by operating the system inside an enclosure 160 in which pressure can be adjusted from normal air pressure to a high vacuum state.

To achieve the highest LBC the magnetic levitation force FDM depends on several factors in this system given as [see M. V. Berry & A. K. Geim, “Of flying frogs & levitrons”, European J. Physics 18, 307 (1997)]:

$${F}_{D M} = \frac{χ}{{μ}_{0}} B \frac{d B}{d y} V \qquad ( 1 )$$

The diamagnetic repulsion force depends on the diamagnet's magnetic susceptibility χ, magnetic field B, magnetic field gradient dB/dy along the vertical direction y and the volume of the diamagnet V. The constant μ₀ is the magnetic permeability in vacuum.

This magnetic levitation system has two sets of parameters: (1) Fixed parameters associated with the given materials of the magnets and diamagnet: magnet's magnetization M, the diamagnet mass density ρ and magnetic susceptibility χ. (2) Free parameters associated with the dimension of the system, such as the magnet radius R, magnet gap g_{M} and the diamagnet radius r.

To maximize the LBC we can optimize only the free parameters and there is at least a set of values that will maximize the LBC. For example, if the radius R is too small, then the size of the supported levitating diamagnet 140 is correspondingly small, and thus will yield a small LBC. If R is too large the levitation will fail, no matter what the levitating diamagnet 140 radius is. Therefore, there is an intermediate, optimum value of R that yield a maximum LBC.

For a given magnet radius R, if the diamagnet radius r is too small it will yield a very small LBC, but if r is too large it will fail to levitate. Thus similarly, there is an optimum value for the diamagnet radius r.

For a given magnet radius R, if the magnet gap g_{M} is too small, there is very little space in between the dipole-line magnets 110/120 which limits the size of the levitating diamagnet 140, resulting in a very small LBC. However, if the gap g_{M} is too large, the levitating diamagnet 140 will fail to levitate. In fact, there is a critical gap g_{C} beyond which the levitation will not occur, given as:

$${g}_{c} = 2 R ( \sqrt[5]{\frac{- 2.069 χ {μ}_{0} {M}^{2}}{( 2 + χ ) ρ g R}} - 1 ) \qquad ( 2 )$$

In general, for the parallel dipole-line (PDL) system the LBC λ will mainly depend on the radius of the magnet R. This LBC is given as:

$$λ ( R ) = \frac{π}{16} ρ {R}^{2} [ - {c}_{0} \frac{χ}{2 + χ} \frac{{μ}_{0} {M}^{2}}{ρ g R} - 1 ] \qquad ( 3 )$$

where c₀ is a constant given as

$${c}_{0} = \frac{{2}^{10}}{{5}^{6}} \sqrt{90 + 42 \sqrt{21 / 5}} = 0.870$$

and g is the gravitational acceleration. This optimum LBC requires a corresponding set of optimum parameters that includes levitating diamagnet 140 radius r and magnet gap g_{M}. They are given as:

$$r = R / 4 and {g}_{M} = {c}_{1} R \qquad ( 4 )$$

with c₁ is a constant given as:

$${c}_{1} = \sqrt{\frac{5}{32} ( 25 + \sqrt{105} )} - 2 = 0.346 .$$

Please note that the levitating diamagnet 140 radius r and magnet gap g_{M} only depend on the magnet radius R. They do not depend on the dipole-line magnets 110/120 and levitating diamagnet 140 properties M, χ and ρ.

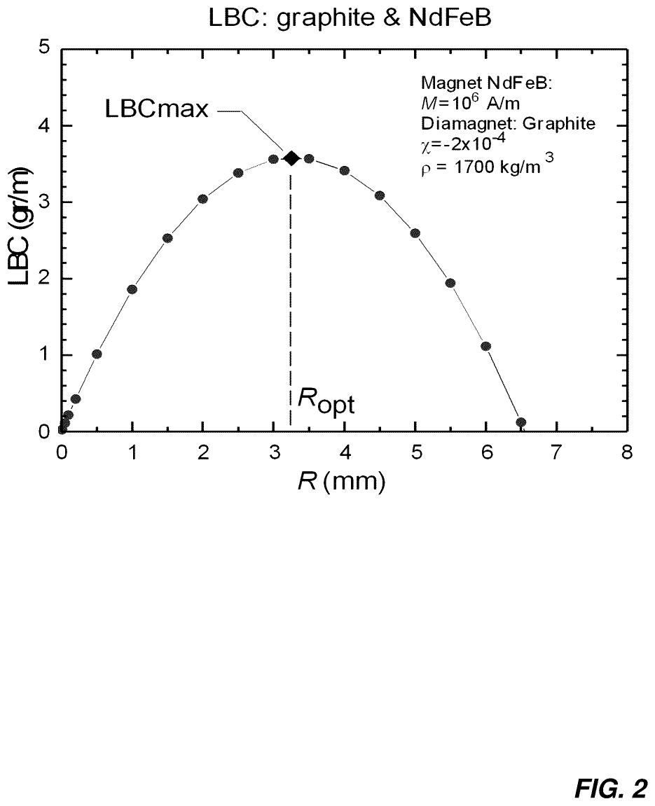

FIG. 2 illustrates a graph of load-bearing capacity (LBC) versus radius (R) for the passive magnetic bearing using diamagnetic levitation 100 depicted in FIG. 1A. FIG. 2 shows the graph of Eq. (3): the LBC vs. magnet radius R. The magnet is a NdFeB type and the diamagnet is graphite. We observe that the LBC initially increases with radius R, reaches a peak value λₘₐₓ at Rₒₚₜ and then finally drops as expected. Their values are given as:

$${R}_{opt} = \frac{B}{2} = \frac{{c}_{0}}{2} \frac{{μ}_{0} {M}^{2}}{ρ g} ( \frac{- χ}{2 + χ} ) \qquad ( 5 )$$

$${λ}_{max} = \frac{{c}_{0}^{2} π}{64} \frac{{μ}_{0}^{2} {M}^{4}}{ρ {g}^{2}} {( \frac{χ}{2 + χ} )}^{2} \qquad ( 6 )$$

These formulas are very useful to estimate the maximum possible LBC for a given dipole-line magnet 110/120 and levitating diamagnet 140. For example, for an NdFeB magnet and graphite diamagnet system we have: Rₒₚₜ=3.3 mm, λₘₐₓ=3.58 gr/m, and the corresponding parameters of optimum diamagnet radius r=0.82 mm and optimum PDL gap: g_{M}=1.13 mm.

In a typical maglev bearing application we have a required LBC λ that will dictate the radius of the magnet R. For this purpose, we can solve for R in Eq. (3) which is given as:

$$R = \frac{B}{2} ( 1 \pm \sqrt{1 - \frac{64 λ}{π ρ {B}^{2}}} ) \qquad ( 7 )$$

The factor B is given as:

$$B = - {c}_{0} \frac{χ}{2 + χ} \frac{{μ}_{0} {M}^{2}}{ρ g} .$$

Please note that since the magnetic susceptibility χ is a negative number, B is a positive number. Similarly, we also have: r=R/4 and g_{M}=c₁R.

An example of a calculation of the LBC for graphite and superconductor bismuth strontium calcium copper oxide (BSCCO, which can be superconducting with liquid nitrogen) is given below:

TABLE 1
LBC calculation for graphite and BSCCO superconductor.

| | | | | | | Dipole Line Magnet | | | |
|---|---|---|---|---|---|---|---|---|---|
| | Diamagnetic Object | | | | | | | Magnet | |
| | | Mass | | Radius | Levitation | | Radius | gap | |
| | | density | Magnetic | optimum | height | Magnetization | optimum | optimum | LBC |
| | | ρ | susceptibility | r | y₀ | M | R | g_{M} | λ |
| No. | Material | (kg/m³) | χ | (m) | (m) | (A/m) | (m) | (m) | (kg/m) |
| 1. | Graphite | 1700 | −2 × 10⁻⁴ | 8.2 × 10⁻⁴ | 2.26 × 10⁻³ | 10⁶ | 3.3 × 10⁻³ | 1.13 × 10⁻³ | 3.58 × 10⁻³ |
| 2. | BSCCOSC | 6400 | −1 | 2.18 | 7.57 | 10⁶ | 8.7 | 3.02 | 9.52 × 10⁴ |
| 3. | BSCCOSC* | 6400 | −1 | 1.15 × 10⁻² | 1.98 × 10⁻² | 10⁶ | 4.6 × 10⁻² | 1.6 × 10⁻² | 10³ |

*Row #3 demonstrates a smaller dimension maglev bearing system using BSCCO that yields an LBC of 1000 kg/m.

From Table 1 we see that for graphite and a typical NdFeB magnet we can obtain a maximum LBC of 3.58 gr/m, but by using BSCCO superconductor we can obtain a very large LBC up to 95,200 kg/m which demonstrates the immense power of superconductor levitation, albeit that requires a very large magnet (R=8.7 m). The LBC for most practical applications is much smaller than this, for example as shown in row #3 Table 1, we can achieve an LBC of 1000 kg/m with NdFeB magnet radius of R=4.6 cm and BSCCO superconductor rod radius of r=1.15 cm, which is very practical to realize.

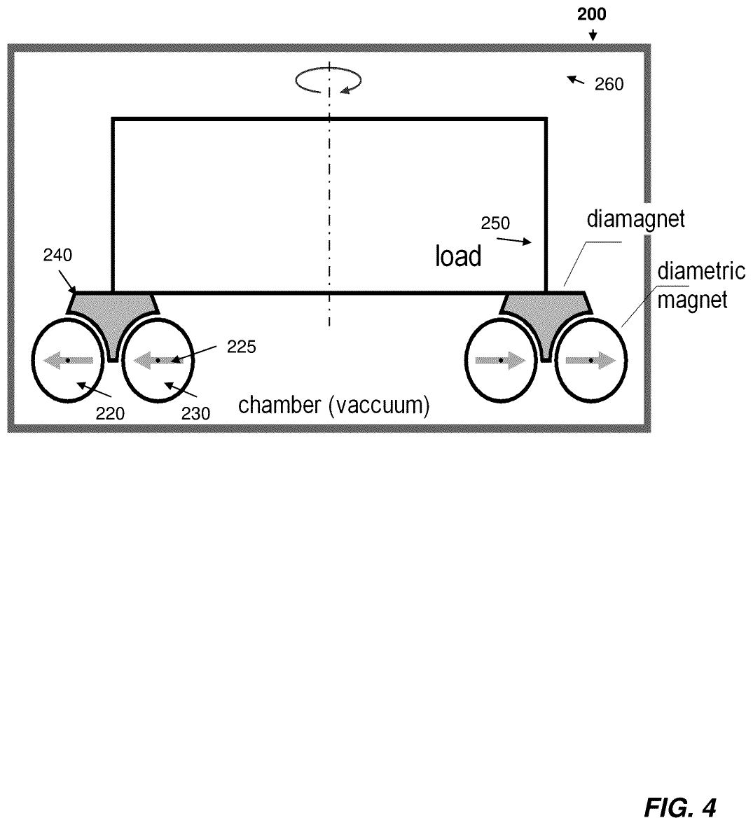

FIG. 4 illustrates a passive magnetic bearing using diamagnetic levitation 200 capable of rotating a load 250, in accordance with an exemplary embodiment of the present invention. The passive magnetic bearing using diamagnetic levitation 200 can include a plurality of dipole magnets (e.g., dipole-line magnets) that can be disposed substantially in parallel, including at least one dipole-line magnet pair. The dipole-line magnet pair can include a first dipole-line magnet 220 and a second dipole-line magnet 230. The first dipole-line magnet 220 and the second dipole-line magnet 230 can have cross-section shapes as described above with respect to FIG. 1, extend in a lengthwise direction (e.g., linear in a top and/or planar view), and/or can extend in a substantially circular direction (e.g., in a circular-track as depicted in FIG. 3B). The passive magnetic bearing using diamagnetic levitation 200 can include at least one levitating diamagnet 240. The at least one levitating diamagnet 240 can be at least partially disposed on surfaces (e.g., the upper surfaces and/or at least partial interior lateral surfaces) of the first dipole-line magnet pair (e.g., the first dipole-line magnet 220 and the second dipole-line magnet 230). The levitating diamagnet 240 can be substantially round (e.g., regular/irregular circle, oval, ellipse, etc.) in a planar and/or top-view and can extend in a substantially circular direction (e.g., conform to the circular-track as depicted in FIG. 3B). For example, a circular dipole-line line magnet track (as depicted in FIG. 3B) can be used to support the levitating diamagnet 240 and a load 250 (e.g., a rotating load) for motion (e.g., rotational). A single or multiple circular dipole line magnet track configuration can be used to support a rotating load 250. The load 250 can be at least partially disposed on the at least one levitating diamagnet 240. The lower surface of the levitating diamagnet 240 can be a complimentary shape to upper and/or partial inner disposed surfaces of the first dipole-line magnet 220 and the second dipole-line magnet 230. Adjacent parallel portions of the first dipole-line magnet 220 and the second dipole-line magnet 230 can have a magnetic field 225 (e.g., permanent, transient, inducible, etc.) with a magnetization in a first direction (e.g., a substantially lateral direction) and opposite corresponding portions can have opposite magnetic field 225 magnetization directions.

The passive magnetic bearing using diamagnetic levitation 200 can be disposed in a vacuum chamber 260. According to an exemplary embodiment, the quantity of passive magnetic bearings using diamagnetic levitation 200 can be increased, for example, in proportion to a desired LBC and/or load 250 size. The damping of the system including the passive magnetic bearing using magnetic levitation 200 can also be controlled by operating the system inside the vacuum chamber 260 in which pressure can be adjusted from normal air pressure to a high vacuum state. The system including the passive magnetic bearing using diamagnetic levitation 200 can be disposed inside the vacuum chamber 260 to eliminate friction loss.

An example application of the present embodiment is a flywheel in which the passive magnetic bearing using diamagnetic levitation 200 supports a high-speed rotational fly wheel for energy storage application.

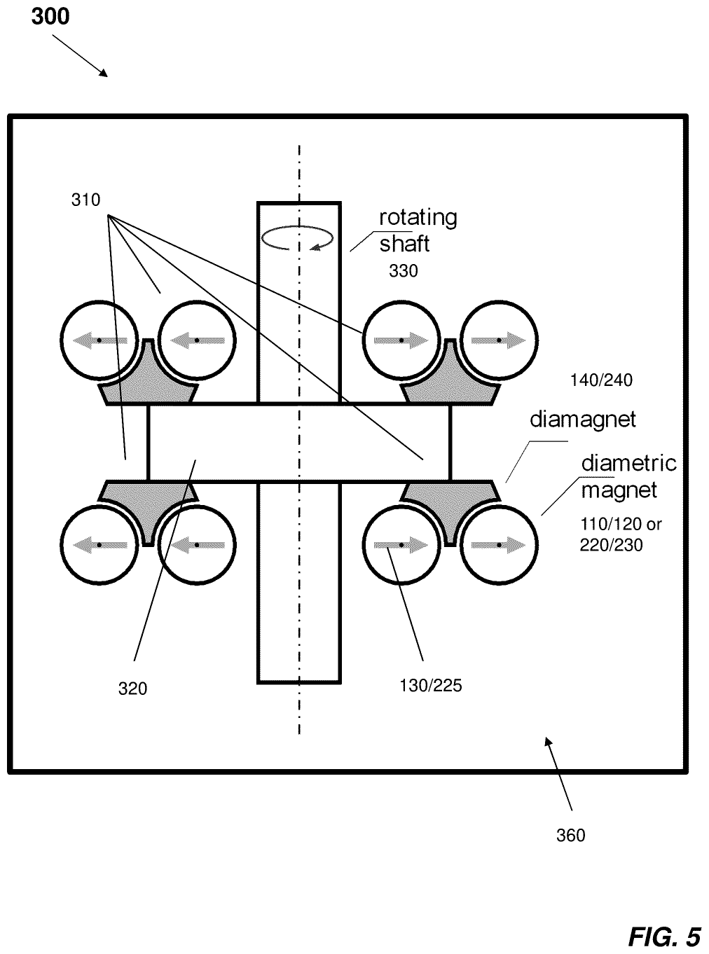

FIG. 5 illustrates a passive magnetic bearing using diamagnetic levitation 300 capable of rotating a shaft, in accordance with an exemplary embodiment of the present invention. The passive magnetic bearing using diamagnetic levitation 300 can include a plurality of passive magnetic bearings 310 (e.g., passive magnetic bearing using diamagnetic levitation 100 and/or passive magnetic bearing using diamagnetic levitation 200). The passive magnetic bearings 310 can be disposed substantially in parallel in at least one direction. For example, the passive magnetic bearings 310 can be disposed in parallel in a lateral direction with aligned upper surfaces and/or in a vertical direction with aligned lateral surfaces. A load 320 (e.g., rotating) can be at least partially disposed between the plurality of passive magnetic bearings 310 (e.g., on upper and/or lower surfaces of the levitating diamagnets 140/240). The levitating diamagnets (e.g., 140/240) can be disposed on dipole-line magnets (e.g., 110/120 or 220/230) with a magnetic field (e.g., 130/225) in at least one direction (e.g., x direction). A shaft 330 (e.g., rotating) can be connected to the load 320. According to an exemplary embodiment, the quantity of passive magnetic bearings using diamagnetic levitation 300 can be increased in proportion to a desired LBC and/or structural support. The damping of the system including the passive magnetic bearing using magnetic levitation 300 can also be controlled by operating the system inside a vacuum chamber (e.g., vacuum chamber 360) and pressure can be adjusted from a normal air pressure to a high vacuum state.

The passive magnetic bearing using diamagnetic levitation 300 can be used in a double rotary application for rotating the shaft 330, such as a turbo pump.

Based on the foregoing, embodiments of a passive magnetic bearing using diamagnetic levitation have been disclosed. However, numerous modifications, additions, and substitutions can be made without deviating from the scope of the exemplary embodiments of the present invention. Therefore, the exemplary embodiments of the present invention have been disclosed by way of example and not by limitation.

What is claimed is:

1. A passive magnetic bearing using diamagnetic levitation, comprising:
a first dipole magnet and a second dipole magnet disposed substantially in parallel, wherein the first dipole magnet and the second dipole magnet are substantially linear;
a levitating diamagnet at least partially disposed on the first dipole-line magnet and the second dipole-line magnet, wherein the levitating diamagnet is substantially linear; and
a load at least partially disposed on the levitating diamagnet.

2. The passive magnetic bearing using diamagnetic levitation of claim 1, wherein the first dipole magnet and the second dipole magnet are substantially round in a cross-sectional view.

3. The passive magnetic bearing using diamagnetic levitation of claim 1, wherein the levitating diamagnet is a complimentary shape to a surface formed by the first dipole magnet and the second dipole magnet.

4. The passive magnetic bearing using diamagnetic levitation of claim 1, wherein each of the levitating diamagnet, the first dipole magnet, and the second dipole magnet extend in a lengthwise direction.

5. The passive magnetic bearing using diamagnetic levitation of claim 1, wherein the first dipole magnet and the second dipole magnet extend in a lengthwise direction.

6. The passive magnetic bearing using diamagnetic levitation of claim 1, wherein the first dipole magnet and the second dipole magnet have a permanent magnetic field in a lateral direction.

7. The passive magnetic bearing using diamagnetic levitation of claim 6, wherein the levitating diamagnet is suspended in a substantially perpendicular direction relative to the lateral direction of the magnetic field.

8. A passive magnetic bearing using diamagnetic levitation, comprising:
at least one dipole magnet pair, wherein the at least one dipole magnet pair includes a first dipole magnet and a second dipole magnet disposed substantially in parallel, wherein the first dipole magnet and the second dipole magnet are a substantially round shape in a top-view;
at least one levitating diamagnet at least partially disposed on the first dipole magnet and the second dipole magnet, wherein the at least one levitating diamagnet is substantially round in a top-view; and
a load at least partially disposed on the at least one levitating diamagnet.

9. The passive magnetic bearing using diamagnetic levitation of claim 8, wherein the first dipole magnet and the second dipole magnet are a substantially round shape in a cross-sectional view.

10. The passive magnetic bearing using diamagnetic levitation of claim 8, wherein the levitating diamagnet is a complimentary shape to a surface formed by the first dipole magnet and the second dipole magnet.

11. The passive magnetic bearing using diamagnetic levitation of claim 8, wherein each of the at least one levitating diamagnet, the first dipole magnet, and the second dipole magnet extend in a circular direction.

12. The passive magnetic bearing using diamagnetic levitation of claim 8, wherein the first dipole magnet and the second dipole magnet have a permanent magnetic field in a lateral direction.

13. The passive magnetic bearing using diamagnetic levitation of claim 12, wherein the levitating diamagnet is suspended in a substantially perpendicular direction relative to the lateral direction of the magnetic field.

14. The passive magnetic bearing using levitation of claim 8, further comprising:
a plurality of dipole magnet pairs disposed substantially in parallel.

15. A passive magnetic bearing using diamagnetic levitation, comprising:
a plurality of dipole magnet pairs, wherein each of the plurality of dipole magnet pairs include a first dipole magnet and a second dipole magnet disposed substantially in parallel, wherein the first dipole magnet and the second dipole magnet are a substantially circular shape in a top-view;
a levitating diamagnet at least partially disposed on the first dipole magnet and the second dipole magnet of each of the plurality of dipole magnet pairs, wherein the levitating diamagnet is a substantially circular shape in a top-view;
a load at least partially disposed between the plurality of dipole magnet pairs; and
a shaft connected to the load.

16. The passive magnetic bearing using diamagnetic levitation of claim 15, wherein the first dipole magnet and the second dipole magnet are a substantially cylindrical shape in a cross-sectional view.

17. The passive magnetic bearing using diamagnetic levitation of claim 15, wherein the levitating diamagnet is a complimentary shape to a surface formed by the first dipole magnet and the second dipole magnet.

18. The passive magnetic bearing using diamagnetic levitation of claim 15, wherein each of the at least one levitating diamagnet, the first dipole magnet, and the second dipole magnet extend in a circular direction.

19. The passive magnetic bearing using diamagnetic levitation of claim 15, wherein the first dipole magnet and the second dipole magnet have a permanent magnetic field in a lateral direction.

20. The passive magnetic bearing using levitation of claim 15, further comprising:
a plurality of dipole magnet pairs disposed substantially in parallel.
